(19) United States
(12) Patent Application Publication
(10) Pub. No.: US 2002/0094771 A1
(43) Pub. Date: Jul. 18, 2002

(54) Rack and method for cleaning and processing game or domestic animals

(76) Inventor: Delton Butler, Meadville, MS (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/042,855

(22) Filed: Jan. 9, 2002

Related U.S. Application Data
(60) Provisional application No. 60/261,899, filed on Jan. 16, 2001.

(51) Int. Cl. A22B 5/16; A22C 17/12; A22C 25/17

(52) U.S. Cl. 452/128

(57) ABSTRACT

An apparatus and method for cleaning and processing a harvested animal is provided. The apparatus comprises a structural frame for suspending the harvested animal and supporting the harvested animal when suspended. The apparatus further includes a hide removal linkage coupled to the hide of the suspended animal at one or more connection points. The apparatus includes a hide remover coupled to the hide removal linkage, wherein the hide remover applies tension through the hide removal linkage on the hide for removing the hide from the suspended animal. The hide remover may or may not itself be coupled to the frame. A plurality of guides coupled to the frame and in communication with the hide removal linkage route the hide removal linkage in a predetermined orientation. Tension, which is applied by the hide remover, is directed by the guides and the hide removal linkage to the hide of the suspended animal such that the hide is separated from the suspended animal and travels according to the preferred orientation. Upon hide removal, the animal may be repositioned for additional processing and cleaning.

### CROSS-REFERENCE TO RELATED APPLICATION

This application claims priority to copending U.S. provisional application entitled, “THE BUTLER RACK,” having serial No. 60/261,899, filed Jan16, 2001, which is entirely incorporated herein by reference.

### FIELD OF THE INVENTION

The present invention relates to an apparatus and method for cleaning and processing game or domestic animals, and more particularly relates to an apparatus and method for removing the skin and dressing a game or domestic animal quickly and easily.

### BACKGROUND OF THE INVENTION

After a game or domestic animal, such as a deer or livestock, is harvested by a hunter in the wild or, in the case of livestock, by a processor in a meat packaging facility, the hunter/processor must skin and process the animal carcass in order to collect the desired meat portions from the animal. (Henceforth, this disclosure will make reference to a game animal with the understanding that game animal also includes domestic animals such as cattle, pigs, and other farm-raised type of harvestable animals.) Typically, the harvested game is moved to a hunting camp or other processing location where the animal may be hoisted in a tree or other hanging structure. Once suspended, the carcass can be skinned and the desired meat can be removed. The skinning process desirably should take place in a way that does not damage the portions of the meat that are to be collected as well other parts of the carcass that are retained, such as a male animal's head and antlers.

As described above, typical skinning and processing methods for harvesting game include hoisting the animal in a tree or from some other permanent structure, such as a barn, etc., so the carcass may be easily accessed thereby enabling the animal's skin to be removed and the undesirable or uncollectible portions separated from the desirable portions of the animal. Because an unprocessed deer carcass may be heavy, it can be difficult to hoist the animal to sufficient height in order to remove the outer skin or hide effectively. Moreover, because of the size of some harvested game animals, the height that the carcass must be raised for skinning may be such that it is difficult to skin without constantly readjusting the height and position.

Typical methods for removing the skin, or hide, from harvested game typically involve manually separating the hide from the deer carcass by exerting physical force. This may be a difficult process due to the inability to place sufficient tension on the hide to easily separate the hide from the carcass for further processing. Some inefficient methods involve attaching the carcass to a movable object such as a vehicle via a cable or rope, and the hide to a stationary object, such as a tree (or vice-versa). By moving the vehicle, the hide may be separated from the carcass. However, this is inefficient and time consuming, as the carcass may have to be raised to an extraordinary height to completely separate the hide from the carcass. Thus, it is often the case that the removal of the hide may be one of the more difficult and time-consuming aspects of processing a game carcass.

Many processing configurations and structures provide for dressing the harvested game in a suspended vertical orientation. This may make reaching inner portions of the harvested game difficult. As a result, processing vertically suspended game may result in an undesirably messy processing environment, which potentially could lead to sanitary issues in regard to the harvested meat.

It is sometimes desirable, upon fully processing and dressing a carcass to allow the carcass to age in the open air for a limited time. This may allow unwanted materials in the carcass to drain thereby enhancing the overall quality of the processed carcass. However, typical processing techniques, described above, wherein a carcass is hung from a tree or other fixed point, result in the carcass merely being hung near the ground. The problem with this configuration is that carcasses left near the ground are vulnerable to other wild game that may attempt to feed upon the aging carcass if within reach. While one solution may be to simply raise the carcass to a sufficient height such that wild animals can not reach the carcass, this solution may not be always available due to the physical imitations of the hoisting mechanism and structure, as well as space restrictions, as the hoist would likely have to be fifteen to twenty feet from the ground to raise larger game to a sufficient height.

As described above, there is a need for a apparatus and method for processing harvested game animals such that the animal carcass may be easily placed into a position for processing and dressing. Furthermore, there is a need for a apparatus and method for quickly and easily removing the outer hide to enable further processing and dressing. As also stated above, there is a need for a apparatus and method for placing a completely processed carcass in a position out of reach of any passing wild game to enable the carcass to age for a limited time. Finally, there is a need for a apparatus and method that solves the problems identified above while also offering portability and maneuverability of the entire apparatus. Consequently, a heretofore under addressed need exists in the industry to address the aforementioned deficiencies and inadequacies set forth above.

### SUMMARY OF THE INVENTION

An apparatus and method for cleaning and processing a harvested game animal is provided. The apparatus comprises a structural frame for suspending the harvested game and supporting the harvested game while suspended. The apparatus further includes a hide removal linkage coupled to the hide of the suspended game at one or more connection points. The apparatus includes a hide remover coupled to the hide removal linkage, wherein the hide remover applies tension through the hide removal linkage on the hide for removing the hide from the suspended game. The hide remover may or may not itself be coupled to the frame. A plurality of guides coupled to the frame and in communication with the hide removal linkage route the hide removal linkage in a predetermined orientation. Tension, which is applied by the hide remover, is directed by the guides and the hide removal linkage to the hide of the suspended game such that the hide is separated from the suspended game and travels according to the predetermined orientation. Upon hide removal, the game may be repositioned for further processing and cleaning.

Other systems, methods, and features, of the present invention will become apparent to one with skill in the art upon examination of the following drawings and detailed description. It is intended that all such additional systems, methods, and features, be included within this description, be within the scope of the invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed on clearly illustrating the principles of the invention. Moreover, in the drawings like reference numerals designate corresponding parts throughout the several views.

FIG. 1 is a perspective view of the apparatus for processing and dressing harvested game.

FIG. 2 is an alternative embodiment of the apparatus of perspective view of FIG. 1.

FIG. 3 is a perspective view of the winching portion of the apparatus FIG. 1 with focus upon the hide removal system.

### DETAILED DESCRIPTION OF THE PREFERRED EMBODIMENT

Having summarized the invention above, reference's now made in detail to the game processing rack as illustrated in the drawings. While the rack will be described in connection with these, there is no intent to limited to the embodiment or embodiments disclosed therein. On the contrary, the intent is to cover all alternatives, modifications, and equivalence included within the spirit and scope defined by the appended claims.

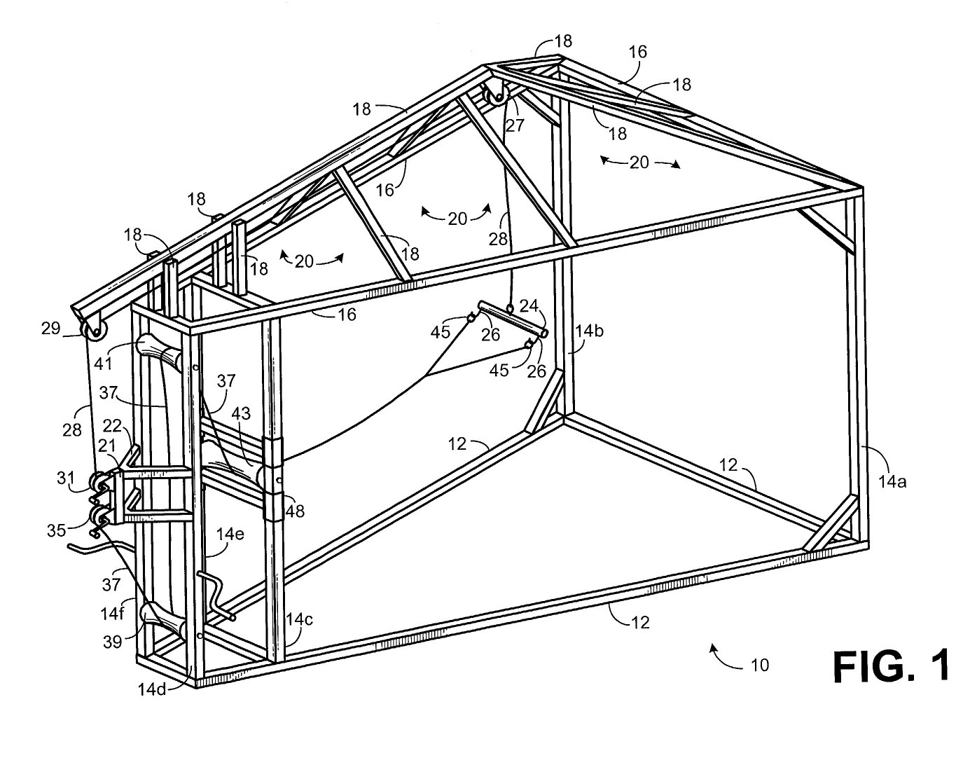

Turning to FIG. 1, one embodiment, among others, of the game processing rack 10 is shown. Game processing rack 10 is comprised of a base portion 12. It should be understood that the base portion 12 may be in other shapes, and one of ordinary skill in the art would understand that the invention is not limited only to the shape shown in FIG. 1. The game processing rack 10 (hereinafter “the rack 10”) has a plurality of vertical members 14. The embodiment, as shown in FIG. 1, has vertical members 14a-14f; however, one of ordinary skill in the art would easily know upon inspection of FIG. 1 that a greater of lessor number of vertical members 14 may be implemented without varying from the spirit and scope of the invention.

More specifically, vertical members 14a and 14b are shown near the rear portion of rack 10 with vertical members 14c, 14d, 14e, and 14f, respectively, near the front portion of the rack. As described in more detail below, vertical members 14c-14f are implemented in a hide removal assembly within rack 10.

A raised frame 16 is connected to vertical members 14. One of ordinary skill in the art would know that raised frame 16 may have configurations in addition to the configuration shown in FIG. 1 without departing from the spirit and scope of the invention as shown and claimed. Attached to the raised frame 16 is raised portion 18, which are supporting members that, as shown in FIG. 1, create a raised portion above the plane of raised frame 16. Raised portion 18 is configured such that it creates a open space 20 between the plane of raised frames 16 and the raised portion 18. This open space 20 is described in more detail below in regard its function and use in the present invention.

It should be noted that FIG. 1 shows several supporting members for raised potion 18, which helps in supporting the weight of the suspended game carcass. It should also be noted that the rack 10 may be constructed with a greater fewer number of raised portion members 18 without departing from the spirit and scope of the invention. Top portion members 18 serve to provide support for hoisting the game animal to a sufficient height and also for creating a open space 20 for potentially storing any harvested and processed game.

It should be apparent to one of ordinary skill in the art that the members of base portion 12, vertical members 14, top frame 16, and raised portion 18 in rack 10 may be of any suitable material. Suitable materials include, but are not limited to metal, wood, plastic, or any other material that may be fastened together. It is desirable that such suitable materials possess the inherent strength, once constructed as rack 10, for supporting the weight of the suspended carcass (i.e., a deer, elk, antelope, moose, cow, pig, etc.) as well as any tensions that may be communicated to the rack 10 as part of the hide removal process, or any other aspect of processing the carcass. Additionally, the individual members of rack 10 (members 12, 14, 16 and 18) may be fastened together in any suitable means including, but not limited to, welding and/or fusing methods, nails, screws, bolts, glue and other similar adhesive methods, etc. All suitable fastening methods are intended to be included within the scope of this invention. Suitable fastening methods are configured so as to withstand all weights and tensions, as described herein.

The members 12, 14, 16 and 18 of rack 10 may be configured in a collapsible format to enable a quick break-down to smaller sized configuration. The collapsed version of rack 10 may provide for reduced storage and/or ease of portability. In making rack 10 collapsible, members 12, 14, 16 and 18 may be connected by hinges, removable bolts, etc. to aid in quick and efficient set up and break down, while maintaining structural strength when rack 10 is substantially arranged as in the perspective view of FIG. 1.

The game animal that is to be processed is attached to a cable 28 by one of several fastening means. Cable 28 may be attached to the neck portion of the game animal when the head portion of the animal is to be hoisted above the hind portion. Alternatively, a bar 24 with hooks 26 may be attached to cable 28 and the hind legs or other hind portion of the harvested game for hoisting the animal in the air in an inverted fashion, wherein the head is nearer to the ground. Bar 24 may be constructed of metal, wood, or other material that provides a sufficient separation between the hind legs or other attachment point of the harvested game. In one embodiment, among others, bar 24 is a metal bar with hooks 26 attached at each end of bar 24 for attaching to the hind legs of the harvested game. In addition, cable 28 may be a metal wire or cable, rope, a chain, or other suitable line wherein the weight of the harvest game once hoisted, as well as any tension that may be exerted on the carcass during processing may be supported.

In one embodiment, among others, cable 28 is constructed of metal wire and has sufficient flexibility to follow the path shown in FIG. 1. Indeed, cable 28 is connected at one end to bar 24 and is routed through pulleys 27 and 29 to a winching device 31. Winching device 31 is attached to vertical members 14d, 14f via mounting plate 21 and support members 22.

Cable 28 is routed through pulleys 27 and 29 to winching device 31. As shown in FIG. 1, winching device 31 is a manual hand-cranked winch. However, one of ordinary skill in the art would recognize that winch 31 may be other similar devices as well. For example, winch 31 may be an electric or automatic winch or other type of device that receives wire 28, as the game carcass is hoisted into the air. As shown in FIG. 1, however, winch 31 is a manual winching device that is operable for winding or unwinding cable 31 for hoisting or lowering the game carcass as desired. Winch 31 provides a locking or stabilizing mechanism for holding the suspended game carcass in a desired position after it is raised from the ground. In other alternative embodiments, winch 31 may be a connection point, or a tie-off point for cable 28 to be tied once the carcass is hoisted from the ground. In this alternative embodiment, the harvested game may be manually hoisted from the ground wherein the cable 28 is tied or fastened to device 31. Thus, device 31 may simply be a connection point for fastening the wire 28 to hold the harvested game at a sufficient position for processing.

In other alternative embodiments, winch 31 may be a movable device not necessarily affixed to rack 10. As non-limiting examples, winch 31 may be an automobile, an all-terrain vehicle, or even a horse, wherein these devices are implemented to move the game carcass from the ground by cable 28. Stated another way, if cable 28 is connected to an automobile, the automobile may be moved sufficiently so that cable 28 moves through pulleys 27 and 29 thereby positioning the carcass off the ground for processing.

Rack 10 includes an additional pulley system for use in removing the hide of the game animal suspended by the pulleys 27, 29, cable 28, and winch 31. A second winch 35 may be coupled to plate 21 and connected through a series of rollers 39, 41, and 43 (or pulleys) for connecting a cable 37 to the animal hide, which is to be removed. More specifically, the winch 35 may be any type of mechanism as similarly described in regard to winch 31. The winch 35, as shown in FIG. 1, is, in this embodiment, a manual hand-cranked winch. The cable 37 that is coupled to the winch 35 and the hide of the game animal may be any type of wire, cable, belt, rope, or other similar device sufficient for supporting the tension created by winch 35 on the hide of the suspended game. The cable 37 is routed from winch 35 around roller 39, which is positioned between the vertical members 14d, 14f. Thereafter, the cable 37 travels vertically to roller 41, which is located near the top of vertical members 14d, 14f. From roller 41, cable 37 travels to roller 43, which is a part of a traveling roller section 48.

In FIG. 1, traveling roller section 48 is shown in a middle position on vertical members 14c, 14e. Prior to removing the hide of the suspended carcass, the traveling section 48 is positioned near the bottom of members 14c, 14e. As further described below, traveling section 48 may travel vertically along members 14c, 14e depending upon whether the hide is being removed or whether the carcass is being suspended in or near open space 20.

As stated above, roller 43 is included in traveling section 48 and cable 37 loops around roller 43 and is connected to the hide of the suspended game near the metal bar 24. At the end points of cable 37 are connection fasteners 45, which attach to the hide of the suspended game at a point proximate to the metal bar 24 prior to the hide being removed from the suspended game. The fasteners 45 may be any fasteners means sufficient for attaching the cable 37 to the hide of the suspended game such that when tension is applied to the hide, the fasteners 45 and cable 37 will operate to separate the hide from the suspended game.

In one embodiment, among others, the fasteners 45 may be flexible rope that can be affixed to the hide near the point where the game is suspended from bar 24. More specifically and as a non-limiting example, if the suspended game is inverted such that the hind legs are attached to bar 24 with the head of the game positioned near the ground, fasteners 45 may be attached to the outer portion of the hide by placing a hard object (i.e., such as a rock, marble, or golf ball) on the inner side of the hide and affixing the fastener 45 to the hide such that the hard object on the under side of the hide protrudes through the connection point of fastener 45. This non-limiting example is but one method for firmly attaching fasteners 45 to the hide such that when tension is applied to the hide, the hide will be pulled off rather than fasteners 45 becoming disconnected from the hide. Other connection methods may implement hooks or other fasteners that are sufficient to remove the hide.

As discussed above, traveling section 48 may be positioned near the bottom portion of members 14c, 14e such that cable 37 creates a zigzag configuration between members 14c-14e and 14d-14f and winch 35. The winch 35 is operated to place tension on the hide of the harvested game via rollers 39, 41 and 43 such that the hide is removed from the suspended game in a downward direction. As the hide is removed from the suspended game, the cable travels in a direction around roller 43, over roller 41, under roller 39, and onto winch 35. In one non-limiting embodiment, rollers 39, 41, and 43 are sufficiently wide such that the hide itself may roll across rollers 39, 41 and/or 43 as the winch 35 operates to receive the cable 37. In this process however, tension is applied to the suspended game, such that the hide is removed and thereafter travels around rollers 39, 41 and 43. During this process, the suspended game, which originally is hanging in a vertical orientation, may be pulled or reoriented in a diagonal direction toward the traveling section 48 along the axis of cable 37.

Winch 35 may be operated to remove the hide from the suspended game to a point sufficient to enable further processing of the carcass. As described above, the winching process may reorient the suspended game from a substantially vertical direction orientation to a horizontal or diagonal/near-horizontal orientation. This horizontal or diagonal/near-horizontal orientation aids the processing of the carcass, as non-removed portions of the carcass, such as internal non-desirables, fall or drain straight from the carcass to the ground rather than draining down the side of the carcass and potentially contaminating portions desired to be further processed. In fact, the carcass being processed can be oriented in a near horizontal direction by moving the traveling section 48 in an upwardly vertical direction along members 14c, 14e, such that the carcass is in a near horizontal direction. In processing a deer, for example, it is desirable to prevent the animal's urine bladder from bursting during processing and contacting desired meat to be collected. By orienting the deer in a horizontal or diagonal/near-horizontal position, any deer urine that escapes from the animal's bladder will fall directly to the ground without contacting and contaminating other portions of the carcass. Moreover, repositioning the carcass to the horizontal or diagonal/near-horizontal orientation makes additional processing easier for the operator, as the carcass may be positioned for the operator's comfort.

In addition, reorientating the carcass to a horizontal or diagonal/near-horizontal position, while maintining tension on the hide of the carcass with winch 35, rollers 39, 41, and 43, and cable 37, provides a safe cleaning and processing environment. In this diagonal to horizontal position, the carcass is held still and does not sway aimlessly as in a suspended vertical orientation.

Traveling section 48 is configured such that it may be temporarily positioned near the bottom, top or any point along members 14c, 14e. Indeed, after the carcass has been completely processed, the traveling section 48 may be positioned near the top of members 14c, 14e such that the carcass is in a horizontal position within open space 20. To place the processed carcass in open space 20, winches 31 and 35 may be further maneuvered, so that resulting tension moves the carcass into space 20.

Once the hide is completely removed and the carcass is completely processed, the fasteners 45 may be disengaged from the carcass allowing the carcass to again be vertically suspended from cable 28 and bar 24. The carcass is then ready for removal from rack 10.

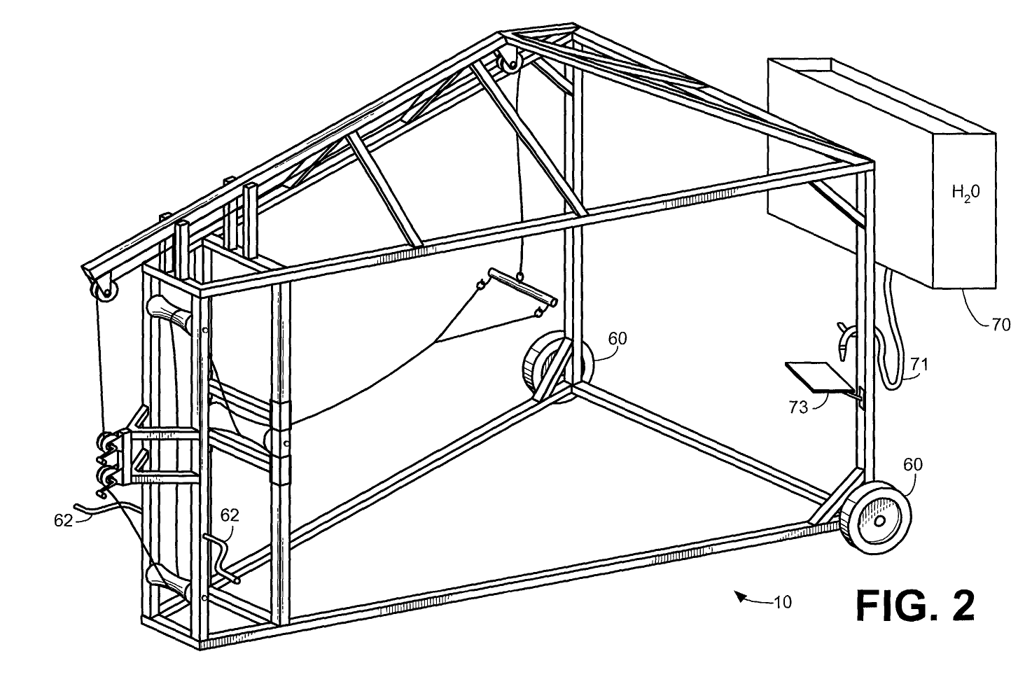

Turning to FIG. 2, an alternative embodiment of rack 10 is shown. In this alternative embodiment, the portability of rack 10 is exhibited. In this alternative embodiment, rack 10 is equipped with engageable wheels 60 attached near the corners of members 14a & 12 and members 14b & 12; however, engageable wheels 60 may be placed in other positions on rack 10 as well. The engageable wheels 60 are configured such that they can be engaged or disengaged to make rack 10 portable for mobility but also stationary when needed for processing of harvested game. When rack 10 is to be moved, engageable wheels 60 may be placed in contact with the ground surface, thereby making rack 10 portable. Similarly, engageable wheels 60 may be disengaged when it is desirable to make rack 10 stationary.

To aid in portability, rack 10 may also be equipped with bars 62 attached to vertical members 14d, 14f so that rack 10 may be moved by lifting handle 62 and rolling wheels 60. Once rack 10 is positioned in the desirable location, the user would lower rack 10 by handles 62 and disengage wheels 60 such that bottom bars 12 are in complete contact with the ground providing stability for rack 10 in processing operations.

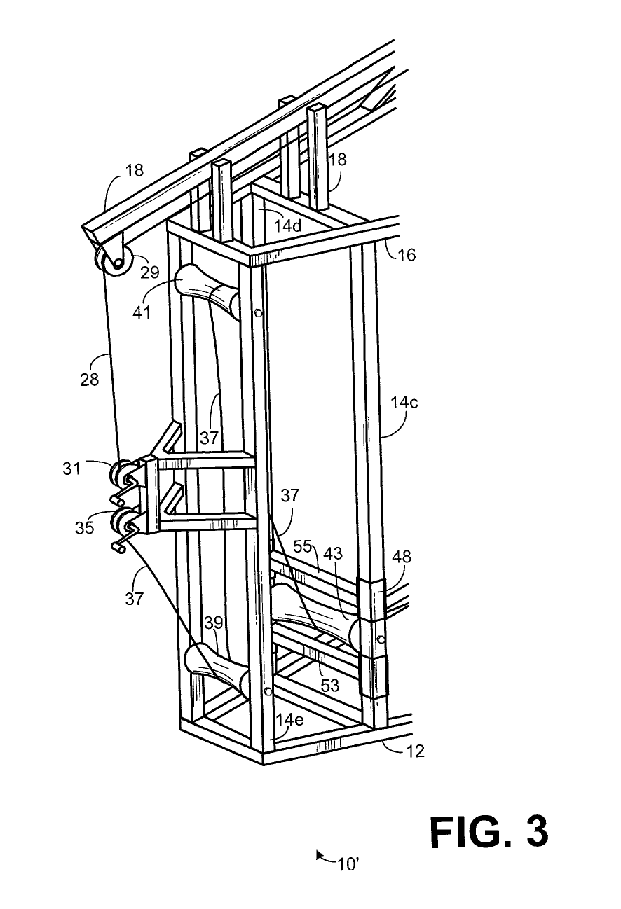

Turning to FIG. 3, the winching and zigzag portion of rack 10′ is depicted. In FIG. 3, the entire rack 10 is not shown, as it may not be necessarily implemented in a configuration to achieve aspects of the present invention. Indeed, rack 10′ may be implemented wherein pulley 27 (FIG.1) may be affixed to structure other than members 18, such as a tree or other point. If a user already has a location to suspend the carcass (i.e., from a tree or from a post or other pre-existing location rack 10′) may be positioned in close proximity such that cable 28 is then coupled to the pre-existing pulley 27 (connected to the tree or other structure) through pulley 29, and onto winch 31, as described above.

The operation of rack 10′ is similar to that described above with regard to removal of the hide, as cable 37 connects to the hide with fastener points 45 (shown in FIG. 1) and routed around rollers 43, 41, and 39 onto winch 35. Thus, the operation in rack 10′ is not different in this regard, but the rest of the rack frame is not illustrated in this alternative embodiment, since a pre-existing pulley 27 suspension point already exists. Just as described above, traveling section 48 includes support members 53 and 55 to slide along vertical members 14c, 14e. The cable 37 and the hide of the harvested game are rolled around roller 43 in the space between roller 43 and support member 53. As stated above, traveling section 48 may be located near the bottom of members 14c, 14e or at any height along members 14c and 14e. For hide removal functions, traveling section 48 is located near the bottom of members 14c and 14e, while for game suspension purposes (such as in space 20 in FIG. 1 or merely in the air in FIG. 3, traveling section 48 is located near the top end of section of members 14c and 14e. In this embodiment rack 10′ is securely attached to the ground or a building so as to exert hoisting and hide-removal tension without moving.

It should also be understood that rollers 39, 41, and 43 are not necessarily rolling devices, but may merely be guides for routing cable 37 and the removed hide (not shown) in a zigzag configuration as previously described. These devices (39, 41, and 43) may be configured to guide the cable 37 through the traveling section 48, over the raised unit 41 and down around the bottom unit (or roller) 39 to winch 35.

In other embodiments that are not shown, rack 10 may be fitted with a soft or hard structure over members 18 to provide cover from the elements if rack 10 is positioned outdoors. Furthermore, rack 10 may be wired with electricity for lights that may be positioned to sufficiently illuminate the area for processing the harvested game. In addition, rack 10 may be equipped with running water or a tank 70 (FIG. 2) and hose 71 (FIG. 2) for cleaning the processed game of undesired substances as well as a utility tray 73 (FIG. 2) for placing processing instruments.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. An apparatus for cleaning and processing a harvested game animal, comprising:
a structural frame for suspending the harvested game and supporting the harvested game when suspended;
a hide removal linkage that couples to the hide of the suspended game at one or more connection points;
a hide remover coupled to the hide removal linkage, wherein the hide remover applies tension through the hide removal linkage on the hide for removing the hide from the suspended game; and
a plurality of guides in communication with the hide removal linkage that route the hide removal linkage in a predetermined orientation, wherein the hide of the suspended game is removed when tension is placed on the hide of the suspended game by the hide remover such that the hide removal linkage and hide travel in a path established by the predetermined orientation of the guides.

2. The apparatus of claim 1, wherein the predetermined orientation of the guides creates a zigzag path for hide removal linkage.

3. The apparatus of claim 1, wherein the predetermined orientation of the guides directs a section of the hide removal linkage in a substantially vertical orientation.

4. The apparatus of claim 1, wherein the predetermined orientation of the guides directs a section of the hide removal linkage in non-horizontal orientation.

5. The apparatus of claim 1, wherein the tension applied on the hide of the suspended game causes the suspended game to become oriented in a non-vertical position.

6. The apparatus of claim 5, wherein the suspended game is further processed and cleaned while oriented in the non-vertical position.

7. The apparatus of claim 1, further comprising:
a traveling section unit coupled to one of the guides, wherein the traveling section unit travels along a vertical plane of the frame.

8. The apparatus of claim 7, wherein the traveling section unit is located near a bottom portion of the vertical plane for removal of the hide of the suspended game.

9. The apparatus of claim 7, wherein the traveling section unit is located near an upper portion of the vertical plane for placing the suspending game in a substantially horizontal configuration.

10. The apparatus of claim 7, wherein the traveling section unit is located at a top portion of the vertical plane for placing the suspending game in a substantially horizontal configuration in an open space of the frame.

11. The apparatus of claim 1, wherein the hide remover is a winch.

12. The apparatus of claim 11, wherein the winch winds the hide removal linkage thereby placing tension on the hide of the suspended game for removing the hide.

13. The apparatus of claim 11, wherein guides route the hide removal linkage and the hide of the suspended game in the predetermined orientation as the winch winds the hide removal linkage.

14. The apparatus of claim 11, further comprising:
an angled top portion on the frame creating an open space within a top portion of the frame for storing processed game.

15. The apparatus of claim 11, further comprising:
engageable wheels attached to the frame, wherein the wheels may be placed in contact with the ground for transporting the frame, and further wherein the wheels may be retracted to make the frame stationary.

16. The apparatus of claim 15, further comprising:
transport bars for handling the frame for transport when the engageable wheels are engaged.

17. A method for cleaning and processing a harvested game animal, comprising the steps of:
suspending the game animal from a rack;
coupling a hide removal linkage to the hide of the suspended game at one or more connection points;
placing tension on the hide of the suspended game with a hide remover coupled to the hide removal linkage; and
routing the hide removal linkage and hide across a plurality of guides in a predetermined orientation, wherein the hide of the suspended game is removed when tension is placed on the hide of the suspended game by the hide remover such that the hide removal linkage and hide travel in a path established by the predetermined orientation of the guides.

18. The method of claim 17 wherein the predetermined orientation of the hide removal linkage and hide routes in a zigzag orientation within the frame.

19. The method of claim 17, further comprising the step of:
placing the suspended game into a substantially horizontal orientation that corresponds to the tension applied by the hide remover.

20. The method of claim 17, further comprising the steps of:
placing the suspended game into an open space in the top portion of the frame.

21. The method of claim 17, further comprising the steps of:
adjusting a traveling roller section for changing the suspension orientation of the game, wherein the suspended game is changed from a substantially vertical orientation to a substantially horizontal orientation according to the position of the traveling roller section.

22. A rack for cleaning and processing a harvested game animal, comprising:
means for suspending the harvested game in a fixed position above the ground;
means for applying tension to the hide of the suspended game through a hide linkage coupled to the hide of the suspended game; and
means for guiding the hide linkage within the frame in a predetermined orientation as tension is applied to the hide, wherein the hide is separated from the game.

23. The rack of claim 22, wherein the predetermined orientation of the hide linkage is in a zigzag orientation.

24. The rack of claim 22, further comprising:
means for placing the suspended game in a top open space of the rack.

25. The rack of claim 22, further comprising:
means for transporting the rack.
